(19) United States
(12) Patent Application Publication
(10) Pub. No.: US 2025/0240531 A1
(43) Pub. Date: Jul. 24, 2025

(54) ELECTRONIC DEVICE FOR ACQUIRING IMAGE BY USING CAMERA, AND OPERATION METHOD THEREOF

(71) Applicant: SAMSUNG ELECTRONICS CO., LTD., Suwon-si (KR)

(72) Inventors: Sungshik KOH, Suwon-si (KR); Sugon Baek, Suwon-si (KR); Bosung Kim, Suwon-si (KR); Jonghoon Won, Suwon-si (KR)

(73) Assignee: SAMSUNG ELECTRONICS CO., LTD., Suwon-si (KR)

(21) Appl. No.: 19/174,576

(22) Filed: Apr. 9, 2025

Related U.S. Application Data
(63) Continuation of application No. PCT/KR2023/015684, filed on Oct. 12, 2023.

(30) Foreign Application Priority Data
Oct. 13, 2022 (KR) 10-2022-0131492
Dec. 2, 2022 (KR) 10-2022-0166483

(51) Int. Cl. H04N 23/69; H04N 23/611; H04N 23/63

(52) U.S. Cl. CPC H04N 23/69; H04N 23/611; H04N 23/632

(57) ABSTRACT

An electronic device including a display, a first camera, a second camera, at least one processor and memory storing computer-executable instructions, when being executed by the at least one processor individually or collectively, causes the electronic device to identify an object region in a first image captured by the second camera; determine a first zoom magnification based on an area of the object region and at least one pre-set reference ratio; display, through the display, a preview screen comprising a second image scaled from at least part of the first image based on the first zoom magnification; receive a user input for the second image; and drive a zoom operation of the first camera such that a zoom magnification of the first camera is adjusted based on a second zoom magnification determined based on the user input.

### CROSS-REFERENCE TO RELATED APPLICATIONS

This application is a continuation application of International Application No. PCT/KR2023/015684 filed on Oct. 12, 2023, which claims priority to Korean Patent Application No. 10-2022-0131492 filed on Oct. 13, 2022 and Korean Patent Application No. 10-2022-0166483 filed on Dec. 2, 2022, in the Korean Intellectual Property Office, the disclosures of which are incorporated by reference herein in their entireties.

### FIELD

The disclosure relates to an electronic device for acquiring an image by using a plurality of cameras, and a method of operating the electronic device.

### BACKGROUND

An electronic device (e.g., a smartphone, a table Personal Computer (PC), a desktop, a digital camera, a notebook PC) may include a plurality of camera modules. The plurality of camera modules may be camera modules having the same feature, or may be camera modules having different features. For example, the electronic device may include an ultra-wide-angle camera, a wide-angle camera, a first telescopic camera, and a second telescopic camera, each of which has a different primary magnification or field of view.

The electronic device may provide an image corresponding to a zoom magnification changed based on a user input for changing the zoom magnification. The electronic device may apply digital zoom to acquire an image having a magnification different from that of an image acquired through a camera. For example, the electronic device may crop at least part of the image acquired through the camera, and may enlarge the cropped image.

The electronic device may include a camera module which supports a continuous optical zoom function. The continuous optical zoom may refer to a function which changes a focal length by moving a lens to enlarge or reduce an image of a subject to be captured in the image. The electronic device may adjust a size of an image formed on an image sensor of a camera by refracting light reflected from the subject through the continuous optical zoom function. Therefore, the image acquired by using the continuous optical zoom may have higher image quality than the image acquired by using the digital zoom.

The aforementioned information may be provided as the related art to aid understanding of the disclosure. No claim or determination is made as to whether any of the aforementioned content is applicable as the prior art related to the disclosure.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

According to various embodiments of the disclosure, there may be provided an electronic device including: a display; a first camera having an optical system configured movably to adjust a magnification of an image to be captured and having a first field of view which changes within a specific range by the movement of the optical system; a second camera having a wider field of view than the first field of view; at least one processor; and memory storing computer-executable instructions, wherein the instructions, when being executed by the at least one processor individually or collectively, may cause the electronic device to: identify an object region in a first image captured by the second camera; determine a first zoom magnification based on an area of the object region and at least one pre-set reference ratio; display, through the display, a preview screen comprising a second image scaled from at least part of the first image, based on the first zoom magnification; receive a user input for the second image; and drive a zoom operation of the first camera such that a zoom magnification of the first camera is adjusted based on a second zoom magnification determined based on the user input.

According to various embodiments of the disclosure, the instructions, when being executed by the at least one processor individually or collectively, may cause the electronic device to determine at least one object ratio of an area occupied by the object region in the second image; and adjust the at least one first zoom magnification based on whether the at least one object ratio corresponds to the at least one pre-set reference ratio.

According to various embodiments of the disclosure, the instructions, when being executed by the at least one processor individually or collectively, may cause the electronic device to acquire a third image captured by the first camera; and determine the second zoom magnification such that a ratio of a region occupied in the third image corresponds to the reference ratio, wherein the region is a region in which a subject corresponding to the object region is captured.

According to various embodiments of the disclosure, the instructions, when being executed by the at least one processor individually or collectively, may cause the electronic device configured to display, through the display, a preview image comprising the third image.

According to various embodiments of the disclosure, the first zoom magnification is a magnification for digital zoom which enlarges or reduces an image through image processing for image data acquired through the second camera, and the second zoom magnification is a magnification for optical zoom which adjusts a magnification of an image acquired through the first camera by controlling the optical system of the first camera.

According to various embodiments of the disclosure, the instructions, when being executed by the at least one processor individually or collectively, may cause the electronic device to acquire depth-of-field information for a subject included in the first image; determine a first effect intensify for the second image based on the depth-of-field information; and blur at least a part of the second image based on the first effect intensify.

According to various embodiments of the disclosure, the instructions, when being executed by the at least one processor individually or collectively, may cause the electronic device to display, through the display, the preview screen further including a fourth image, and wherein the fourth image includes an image scaled from the first image based on a third magnification obtained by multiplying the first zoom magnification by a pre-set ratio.

According to various embodiments of the disclosure, the instructions, when being executed by the at least one processor individually or collectively, may cause the electronic device to: determine a second effect intensity different from the first effect intensity based on the third magnification; and blur at least a part of the fourth image based on the second effect intensity.

According to various embodiments of the disclosure, the instructions, when being executed by the at least one processor individually or collectively, may cause the electronic device to adjust the first effect intensity based on a change in the first zoom magnification.

According to various embodiments of the disclosure, the instructions, when being executed by the at least one processor individually or collectively, may cause the electronic device to identify a face in the first image; and determine a region corresponding to the identified face as the object region.

According to various embodiments of the disclosure, there may be provided a method of operating an electronic device comprising a first camera having an optical system configured movably to adjust a magnification of an image to be captured and having a first field of view which changes within a specific range by the movement of the optical system and a second camera having a wider field of view than the first field of view, the method including: identifying an object region in a first image captured by the second camera; determining a first zoom magnification, based on an area of the object region and at least one pre-set reference ratio; displaying a preview screen comprising a second image scaled from at least part of the first image based on the first zoom magnification; receiving a user input for the second image; and driving a zoom operation of the first camera such that a zoom magnification of the first camera is adjusted based on a second zoom magnification determined based on the user input.

According to various embodiments of the disclosure, the method may further include determining at least one object ratio of an area occupied by the object region in the second image; and adjusting the at least one first zoom magnification based on whether the at least one object ratio corresponds to the at least one pre-set reference ratio.

According to various embodiments of the disclosure, the method may further include acquiring a third image captured by the first camera; and determining the second zoom magnification such that a ratio of a region occupied in the third image corresponds to the at least one pre-set reference ratio, the region being a region in which a subject corresponding to the object region is captured.

According to various embodiments of the disclosure, the displaying of the preview screen may include displaying a preview image comprising the third image.

According to various embodiments of the disclosure, the method may be provided, wherein the first zoom magnification is a magnification for digital zoom which enlarges or reduces an image through image processing for image data acquired through the second camera, and wherein the second zoom magnification is a magnification for optical zoom which adjusts a magnification of an image acquired through the first camera by controlling the optical system of the first camera.

A computer readable non-transitory storage medium according to an embodiment may be a computer program recorded to execute the aforementioned method.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1 is a block diagram illustrating an electronic device in a network environment according to various embodiments.

FIG. 2 is a block diagram illustrating the camera module according to various embodiments.

FIG. 3 is a block diagram of an electronic device according to an embodiment;

FIG. 4 illustrates an example of a first image captured by an electronic by using a second camera according to an embodiment;

FIG. 5 illustrates an example of a second image created by an electronic device, based on a first image, according to an embodiment;

FIG. 6 illustrates an example of a preview screen displayed by an electronic device according to an embodiment;

FIG. 7 illustrates an example of a preview screen changed based on a user input according to an embodiment;

FIG. 8 illustrates an example of a process in which an electronic device displays a preview screen, based on a user input, according to an embodiment;

FIG. 9 is a flowchart illustrating a process in which an electronic device drives a zoom operation of a first camera according to an embodiment;

FIG. 10 is a flowchart illustrating a process in which an electronic device adjusts a zoom magnification according to an embodiment;

FIG. 11 is a flowchart illustrating a process in which an electronic device applies an image effect to a second image included in a preview screen according to an embodiment;

FIGS. 12A, 12B, and 12C are drawings for explaining depth-of-field information for applying an image effect to a second image by an electronic device according to an embodiment; and

FIG. 13 is a flowchart illustrating a process in which an electronic device acquires an image by using a first camera and a second camera according to an embodiment.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness.

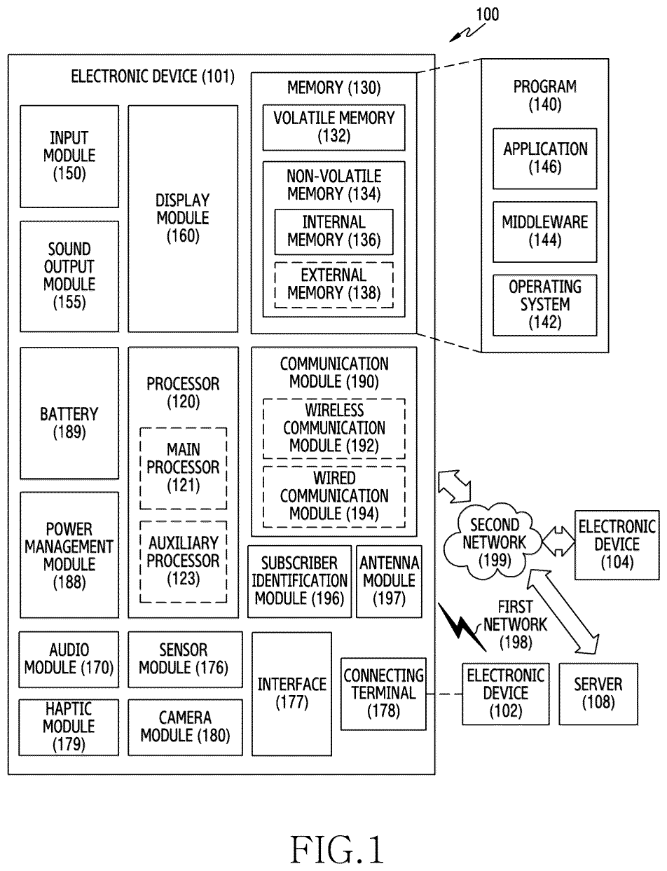

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

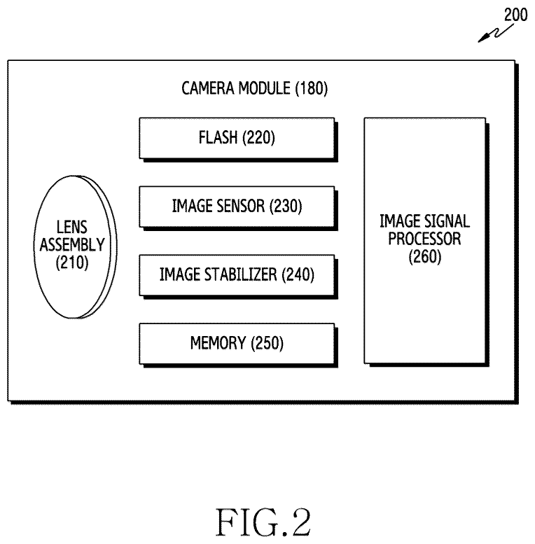

FIG. 2 is a block diagram illustrating the camera module 180 according to various embodiments. Referring to FIG. 2, the camera module 180 may include a lens assembly 210, a flash 220, an image sensor 230, an image stabilizer 240, memory 250 (e.g., buffer memory), or an image signal processor 260. The lens assembly 210 may collect light emitted or reflected from an object whose image is to be taken. The lens assembly 210 may include one or more lenses. According to an embodiment, the camera module 180 may include a plurality of lens assemblies 210. In such a case, the camera module 180 may form, for example, a dual camera, a 360-degree camera, or a spherical camera. Some of the plurality of lens assemblies 210 may have the same lens attribute (e.g., view angle, focal length, auto-focusing, f number, or optical zoom), or at least one lens assembly may have one or more lens attributes different from those of another lens assembly. The lens assembly 210 may include, for example, a wide-angle lens or a telephoto lens.

The flash 220 may emit light that is used to reinforce light reflected from an object. According to an embodiment, the flash 220 may include one or more light emitting diodes (LEDs) (e.g., a red-green-blue (RGB) LED, a white LED, an infrared (IR) LED, or an ultraviolet (UV) LED) or a xenon lamp. The image sensor 230 may obtain an image corresponding to an object by converting light emitted or reflected from the object and transmitted via the lens assembly 210 into an electrical signal. According to an embodiment, the image sensor 230 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 230 may be implemented using, for example, a charged coupled device (CCD) sensor or a complementary metal oxide semiconductor (CMOS) sensor.

The image stabilizer 240 may move the image sensor 230 or at least one lens included in the lens assembly 210 in a particular direction, or control an operational attribute (e.g., adjust the read-out timing) of the image sensor 230 in response to the movement of the camera module 180 or the electronic device 101 including the camera module 180. This allows compensating for at least part of a negative effect (e.g., image blurring) by the movement on an image being captured. According to an embodiment, the image stabilizer 240 may sense such a movement by the camera module 180 or the electronic device 101 using a gyro sensor (not shown) or an acceleration sensor (not shown) disposed inside or outside the camera module 180. According to an embodiment, the image stabilizer 240 may be implemented, for example, as an optical image stabilizer. The memory 250 may store, at least temporarily, at least part of an image obtained via the image sensor 230 for a subsequent image processing task. For example, if image capturing is delayed due to shutter lag or multiple images are quickly captured, a raw image obtained (e.g., a Bayer-patterned image, a high-resolution image) may be stored in the memory 250, and its corresponding copy image (e.g., a low-resolution image) may be previewed via the display device 160 (also referred to as display module 160). Thereafter, if a specified condition is met (e.g., by a user's input or system command), at least part of the raw image stored in the memory 250 may be obtained and processed, for example, by the image signal processor 260. According to an embodiment, the memory 250 may be configured as at least part of the memory 130 or as a separate memory that is operated independently from the memory 130.

The image signal processor 260 may perform one or more image processing with respect to an image obtained via the image sensor 230 or an image stored in the memory 250. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 260 may perform control (e.g., exposure time control or read-out timing control) with respect to at least one (e.g., the image sensor 230) of the components included in the camera module 180. An image processed by the image signal processor 260 may be stored back in the memory 250 for further processing, or may be provided to an external component (e.g., the memory 130, the display device 160, the electronic device 102, the electronic device 104, or the server 108) outside the camera module 180. According to an embodiment, the image signal processor 260 may be configured as at least part of the processor 120, or as a separate processor that is operated independently from the processor 120. If the image signal processor 260 is configured as a separate processor from the processor 120, at least one image processed by the image signal processor 260 may be displayed, by the processor 120, via the display device 160 as it is or after being further processed.

According to an embodiment, the electronic device 101 may include a plurality of camera modules 180 having different attributes or functions. In such a case, at least one of the plurality of camera modules 180 may form, for example, a wide-angle camera and at least another of the plurality of camera modules 180 may form a telephoto camera. Similarly, at least one of the plurality of camera modules 180 may form, for example, a front camera and at least another of the plurality of camera modules 180 may form a rear camera.

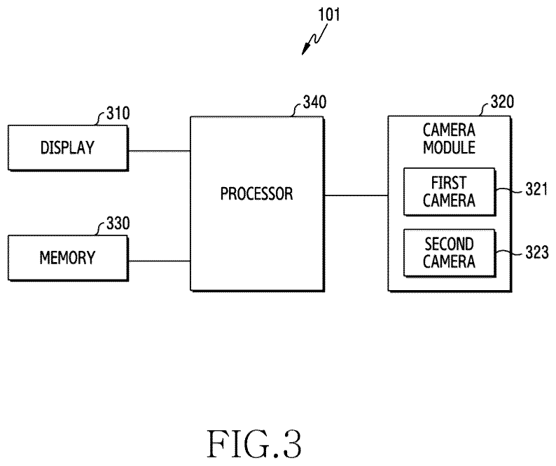

FIG. 3 is a block diagram of an electronic device 101 according to an embodiment.

The electronic device 101 according to an embodiment may include a display 310 (e.g., the display module 160 of FIG. 1), a camera module 320 (e.g., the camera module 180 of FIG. 1 or FIG. 2), a memory 330 (e.g., the memory 130 of FIG. 1), and a processor 340 (e.g., the processor 120 of FIG. 1). However, the components of the electronic device 101 of FIG. 3 are for explaining the embodiment, and some of the components may be omitted or may be replaced with other components. For example, the electronic device 101 may not include the display 310, and may output a screen through a display of an external device.

According to an embodiment, the camera module 320 may include a first camera 321 and a second camera 323. The first camera 321 and the second camera 323 may be disposed to capture an image in the same or parallel direction with respect to the electronic device 101.

The first camera 321 may be configured to support a first field of view which changes within a specific range according to a supported optical zoom operation. The second camera 323 may be configured to support a second field of view wider than the first field of view. For example, the first camera 321 may include a telescopic camera, and the second camera 323 may include a wide-angle camera. The first camera 321 may be configured to have a focal length longer than that of the second camera 323.

According to an embodiment, the first camera 321 may include a camera which supports an optical zoom function. The first camera 321 may drive an optical system of the first camera 321 so that a magnification of an image to be captured is continuously adjusted under the control of the processor 340. The first camera 321 may include a lens assembly (e.g., the lens assembly 210 of FIG. 2) capable of adjusting a focal length to adjust the magnification of the image. Optical zoom may refer to an operation of a camera which moves a lens (e.g., a lens included in the first camera 321) to a position corresponding to a zoom magnification and acquires an image by using light collected through the moved lens.

In an embodiment, the camera module 320 may include a component for moving the position of the lens. For example, the camera module 320 may include an actuator for moving a position of a lens included in the first camera 321, a controller for controlling an operation of the actuator, and a memory (e.g., the memory 250 of FIG. 2) for storing information on the position of the lens. However, the structure of the camera module 320 is not limited thereto.

In an embodiment, the processor 340 may execute instructions stored in the memory 330 to perform an arithmetic operation or may control the component of the electronic device 101. The processor 340 may include one or more hardware components. In the disclosure, the operation of the electronic device 101 may be performed under the control of the processor 340.

In an embodiment, the processor 340 may capture a first image by using the second camera 323. The first image may be an image captured based on the second field of view supported by the second camera 323. A wider region may be captured in the first image than a region captured by using the first camera 321.

In an embodiment, the processor 340 may identify an object region within the first image. In the disclosure, the object region may refer to a region having pixels disposed thereon, in which an object is determined as being captured in an image. For example, the processor 340 may perform semantic segmentation on the first image to classify a class of pixels in the first image. The processor 340 may identify the region of pixels, of which a class is classified as a face, as the object region. However, the operation in which the processor 340 identifies the object region is not limited thereto. For example, the processor 340 may identify the object region by using another method other than the semantic segmentation, or may identify another region (e.g., a region in which an animal is captured) other than the face as the object region.

In an embodiment, the processor 340 may determine a first zoom magnification, based on an area of the object region and a reference ratio. The processor 340 may determine a ratio of the area of the object region occupied in the first image. For example, when an entire area of the first image is 10 and an area of the object region is 1, the ratio of the object region occupied therein may be determined to be 10:1. In the disclosure, the ratio of the area of the identified object region occupied in the image may be referred to as an object ratio. For example, the processor 340 may determine a ratio of a length for the first image and a length of a region in which the object region appears in the first image. For example, the object ratio may include a ratio of a longitudinal length of the object region to a longitudinal length of the image.

The reference ratio may be a value pre-set in the electronic device. For example, the reference ratio may be a ratio recommended to take a photo of a person. The processor 340 may scale (e.g. enlarge or reduce) the first image to determine the first zoom magnification such that a ratio of an area of an enlarged or reduced object region to the entire area of the first image is equal to the reference ratio or within a specified range from the reference ratio. The reference ratio may be different depending on a shooting mode. For example, a reference ratio for a case where a portrait shooting mode is selected in a camera application may differ from a reference ratio for a case where a food shooting mode is selected. Herein, the processor 340 may identify a region in which a face of a person is shot as the object region when the portrait shooting mode is selected, and may identify a region in which food is shot as the object region when the food shooting mode is selected.

In an embodiment, the processor 340 may dynamically adjust a first magnification to maintain a state where an area of an object region in an image stream output through the second camera 323 corresponds to the reference ratio.

In an embodiment, the processor 340 may acquire a second image by enlarging or reducing the first image, based on the first magnification. The processor 340 may crop a region including the object region in the first image and acquire the second image enlarged or reduced from the cropped region. For example, the processor 340 may configure the second image so that a user's face and part of an upper body appear to provide a portrait composition.

In an embodiment, the processor 340 may further determine a magnification for providing another composition, based on the first magnification. For example, the processor 340 may acquire an image having a face photo composition, based on a magnification corresponding to 150% of the first magnification. Similarly, the processor 340 may acquire an image having an intermediate composition, based on a magnification corresponding to 80% of the first magnification, or may acquire an image having a person composition including a lower body, based on a magnification corresponding to 50% of the first magnification.

In an embodiment, the processor 340 may control the display 310 to display a preview image including the second image. The second image may be composed of a thumbnail image displayed on part of the display 310. In the disclosure, the thumbnail image may refer to a small-sized preview image which is streamed to be updated continuously. In addition, the second image displayed on the display 310 may be a live preview image updated continuously based on an image captured by using the second camera. The second image may be provided as a still image. The preview image displayed on the display 310 may include thumbnail images having a plurality of recommended compositions including the second image. For example, the preview image may include at least one of the aforementioned images, i.e., the image having the portrait composition, the image having the face photo composition, the image having the intermediate composition, and the image having the person composition including the lower body.

In an embodiment, the processor 340 may acquire a third image through the first camera 321. The processor 340 may display a preview image including at least part of the third image. For example, the processor 340 may control the display 310 to display the third image in a most of a region of the display 310 as a primary image and display the second image in a relatively small region of the display 310 as a thumbnail image.

In an embodiment, the processor 340 may maintain an object ratio in the second image, so as to be within a specified range from the reference ratio. When a subject moves away from a camera (e.g., the second camera 323), a region in which an object is displayed may be reduced in the second image. Therefore, the processor 340 may maintain the object ratio by increasing the first zoom magnification. For example, the processor 340 may periodically or repeatedly compare the object ratio and the reference ratio to determine whether to adjust the first zoom magnification. As another example, the processor 340 may acquire distance information between the camera and the subject, and may change the first zoom magnification, based a change in the distance information.

In an embodiment, the processor 340 may receive a user input for the second image. For example, when the display 310 includes a touch screen capable of detecting a touch input, the processor may receive the touch input corresponding to a position at which the second image is displayed. The processor 340 may determine a second zoom magnification of the first camera 321 so that the third image has a composition corresponding to the second image, based on the user input for the second image. The second zoom magnification may refer to a magnification adjusted by using an optical zoom function of the first camera 321. For example, when a ratio of a face occupied in the second image is 10% and a ratio of a face occupied in the third image captured by using the first camera 321, based on a 1.0× magnification, is 5%, the processor 340 may determine a 2.0× magnification as the second zoom magnification.

In an embodiment, the processor 340 may drive a zoom operation of the first camera 321, based on the second zoom magnification determined based on the user input. For example, when the second zoom magnification is determined to be 2.0× in a state where a zoom magnification is set to 1.0× in the first camera 321, the processor 340 may control the camera module 320 to move a position of a lens of the first camera 321 such that a size of an image formed on an image sensor of the first camera 321 doubles.

In an embodiment, the processor 340 may apply an image effect such that the second image to be displayed on the display 310 is displayed similarly to an image acquired after changing the zoom magnification of the first camera 321. The second image is created based on the image acquired through the second camera 323 having a feature different from that of the first camera 321, and thus at least some regions may be presented to be different from the image acquired through the first camera 321. For example, a focal length of a lens changes in the first camera 321 when an optical zoom function is performed, and another extra feature (e.g., an aperture value) may also be different. Therefore, the second image may have a different bokeh effect in which at least some regions appearing in the third image are blurred. The processor 340 may predict the bokeh effect appearing in an image captured based on the changed optical zoom magnification and may blur at least some regions of the second image. The processor 340 may apply an image effect to each image of different compositions, displayed on the preview image, corresponding to different optical zoom magnifications.

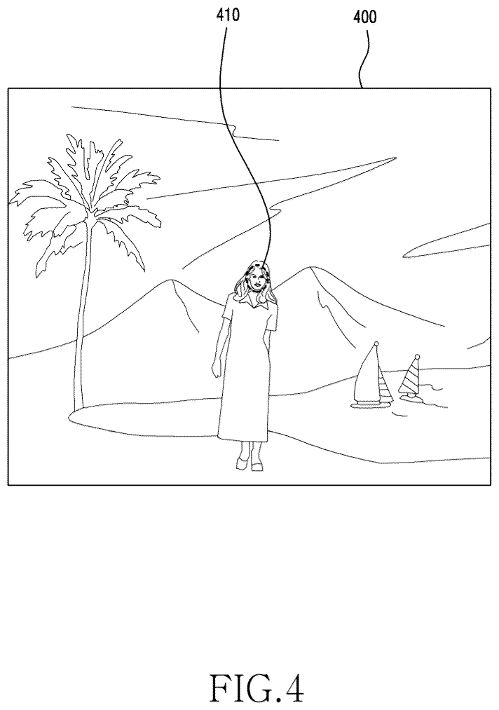

FIG. 4 illustrates an example of a first image 400 captured by an electronic device (e.g., the electronic device 101 of FIG. 1, 2, or 3) by using a second camera (e.g., the second camera 323 of FIG. 3) according to an embodiment.

When the second camera (e.g., the second camera 323 of FIG. 3) supports a wider field of view than a first camera (e.g., the first camera 321 of FIG. 3), the second camera (e.g., the second camera 323 of FIG. 3) may acquire the first image 400 including a subject located in a wider space than an image captured by using the first camera (e.g., the first camera 321 of FIG. 3).

The electronic device (e.g., the electronic device 101 of FIG. 1, 2, or 3) may identify an object region 410 in which an object (e.g., a face) is captured from the first image 400. The electronic device (e.g., the electronic device 101 of FIG. 1, 2, or 3) may acquire an image for providing a preview image, based on an area of the identified object region 410.

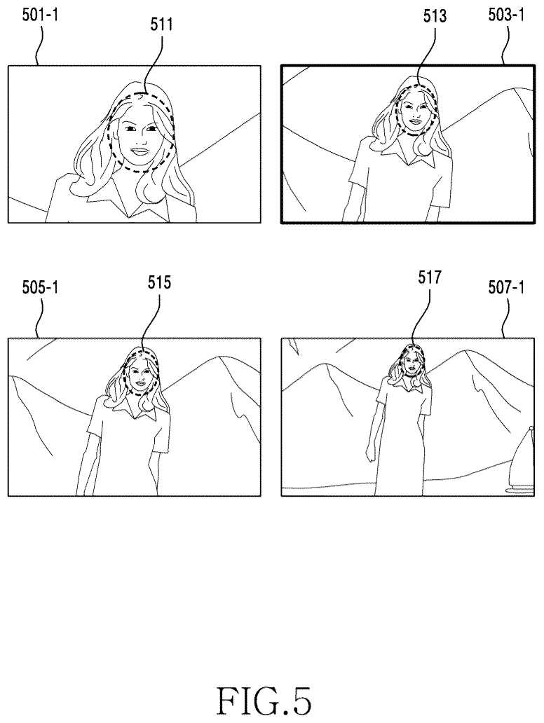

FIG. 5 illustrates an example of a second image 503-1 created by an electronic device (e.g., the electronic device 101 of FIG. 1, 2, or 3), based on a first image (e.g., the first image 400 of FIG. 4), according to an embodiment.

The electronic device (e.g., the electronic device 101 of FIG. 1, 2, or 3) may determine a first zoom magnification such that a ratio of an area of an object region 513, which is enlarged or reduced from an object region (e.g., the object region 410 of FIG. 4) recognized in a first image (e.g., the first image 400 of FIG. 4), occupied in the second image 503-1 corresponds to a reference ratio. The electronic device (e.g., the electronic device 101 of FIG. 1, 2, or 3) may perform a digital zoom operation which enlarges or reduces the first image (e.g., the first image 400 of FIG. 4), based on the determined first zoom magnification, and crops a portion corresponding to the second image 503-1 including the object region 513.

The electronic device (e.g., the electronic device 101 of FIG. 1, 2, or 3) may further create images 501-1, 505-1, and 507-1 having different compositions, based on the determined first zoom magnification. Ratios of areas occupied by object regions 511, 515, and 517 included in the respective images 501-1, 505-1, and 507-1 may be configured to be different from one another.

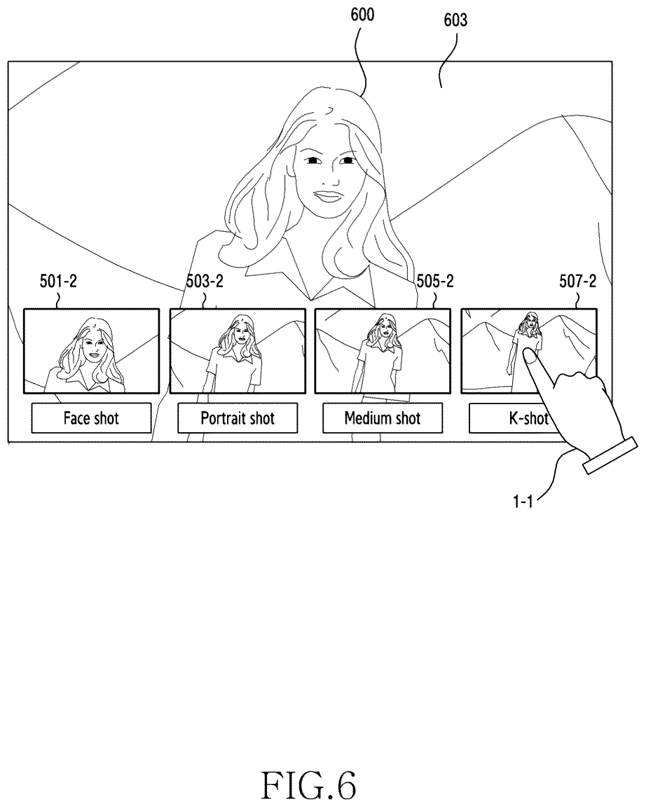

FIG. 6 illustrates an example of a preview screen 600 displayed by an electronic device (e.g., the electronic device 101 of FIG. 1, 2, or 3) according to an embodiment.

The electronic device (e.g., the electronic device 101 of FIG. 1, 2, or 3) according to an embodiment may display the preview screen 600 including a third image 603 acquired through a first camera (e.g., the first camera 321 of FIG. 3) through a display (e.g., the display 310 of FIG. 3) and thumbnails 501-2, 503-2, 505-2, and 507-2 created based on an image acquired through a second camera (e.g., the second camera 323 of FIG. 3). The third image 603 and thumbnails 501-2, 503-2, 505-2, and 507-2 included in the preview screen 600 of the electronic device (e.g., the electronic device 101 of FIG. 1, 2, or 3) may be a live preview image which is updated persistently or periodically. The electronic device (e.g., the electronic device 101 of FIG. 1, 2, or 3) may dynamically adjust an optical zoom magnification of the first camera 321 and a digital zoom magnification for the image acquired through the second camera 323 to maintain compositions of the third image 603 and thumbnails 501-2, 503-2, 505-2, and 507-2 included in the preview screen 600.

In an embodiment, the electronic device (e.g., the electronic device 101 of FIG. 1, 2, or 3) may dynamically adjust the digital zoom magnification for the image acquired through the second camera 323 to maintain the compositions of the thumbnails 501-2, 503-2, 505-2, and 507-2. When the optical zoom magnification of the first camera 321 is not dynamically adjusted, the composition of the third image 603 may change depending on a change in a distance between the first camera 321 and a subject. After the composition of the third image 603 changes, the electronic device (e.g., the electronic device 101 of FIG. 1, 2, or 3) may control an optical zoom operation of the first camera 321 to change the composition of the third image 603, based on a user input for selecting any one of the thumbnails 501-2, 503-2, 505-2, and 507-2.

The electronic device (e.g., the electronic device 101 of FIG. 1, 2, or 3) according to an embodiment may detect a user input for at least one of the thumbnails 501-2, 503-2, 505-2, and 507-2 included in the preview screen 600 which is input by a user 1-1. For example, the electronic device (e.g., the electronic device 101 of FIG. 1, 2, or 3) may detect a touch input corresponding to a region in which the second image 507-2 is displayed through a touch screen of a display (e.g., the display 310 of FIG. 3).

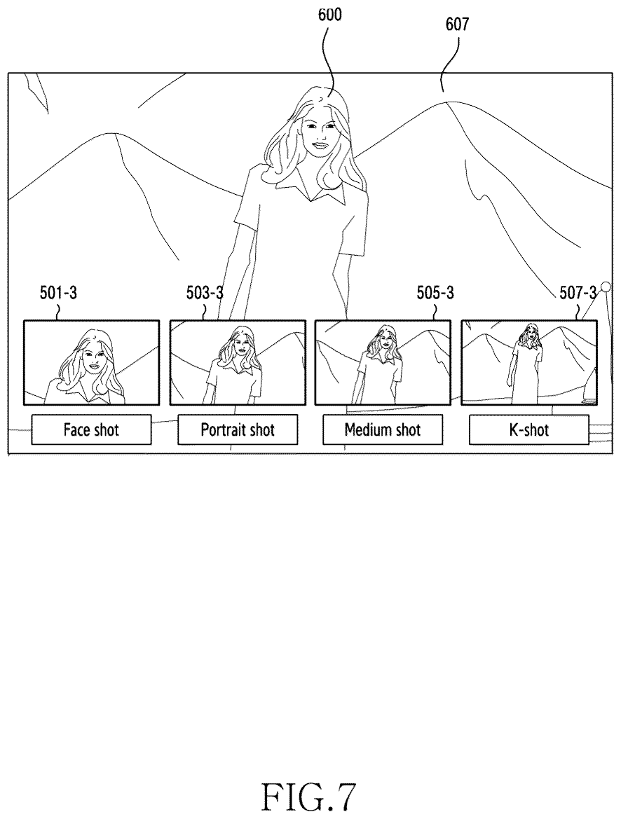

FIG. 7 illustrates an example of a preview screen 600 changed based on a user input according to an embodiment.

In an embodiment, an electronic device (e.g., the electronic device 101 of FIG. 1, 2, or 3) may control an optical zoom magnification of a first camera (e.g., the first camera 321 of FIG. 3) such that a composition of a third image 607 displayed on the preview screen 600 corresponds to a composition of a selected second image (e.g., the second image 507-2 of FIG. 2), based on a user input for the second image (e.g., the second image 507-2 of FIG. 2).

Since the preview screen 600 is provided based on an image acquired based on an adjusted optical zoom magnification (e.g., a second zoom magnification) of the first camera (e.g., the first camera 321 of FIG. 3), the first camera (e.g., the first camera 321 of FIG. 3) may be controlled to capture an image having a composition corresponding to a composition selected by a user. While adjusting the optical zoom magnification of the first camera (e.g., the first camera 321 of FIG. 3), the electronic device (e.g., the electronic device 101 of FIG. 1, 2, or 3) may dynamically adjust a digital zoom magnification for acquiring thumbnails 501-3. 503-3, 505-3, and 507-3 from an image acquired through the second camera (e.g., the second camera 323 of FIG. 3) to maintain compositions of the thumbnails 501-3. 503-3, 505-3, and 507-3.

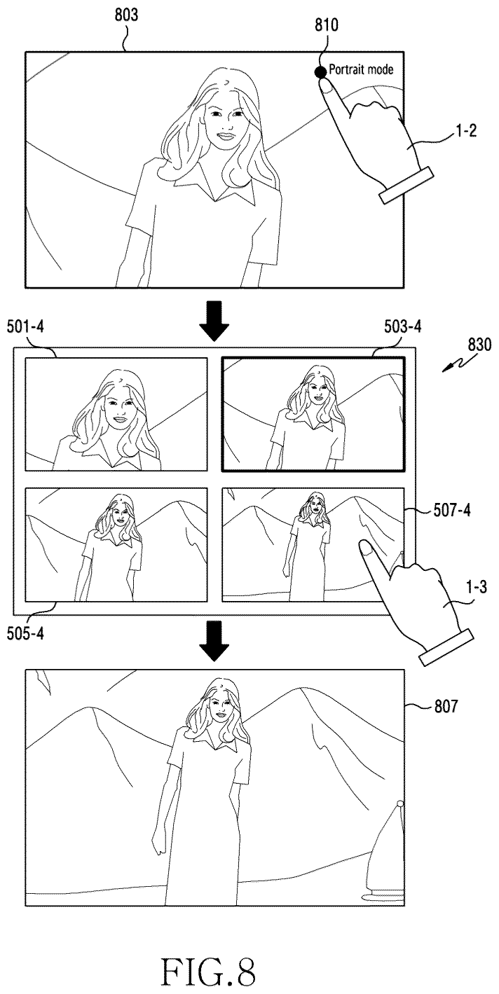

FIG. 8 illustrates an example of a process in which an electronic device (e.g., the electronic device 101 of FIG. 1, 2, or 3) displays a preview screen, based on a user input, according to an embodiment.

In an embodiment, the preview screen 600 provided by the electronic device (e.g., the electronic device 101 of FIG. 1, 2, or 3) is not limited to the form illustrated in FIG. 6 and FIG. 7. Referring to FIG. 8, the electronic device (e.g., the electronic device 101 of FIG. 1, 2, or 3) may provide the preview screen, based on a third image 803 acquired through a first camera (e.g., the first camera 321 of FIG. 3) in a state where a camera application is executed. The electronic device may display a visual object 810 for recommending a composition of a photo together with the third image 803. A user 1-2 may input a user input for selecting the visual object 810 to the electronic device (e.g., the electronic device 101 of FIG. 1, 2, or 3).

In an embodiment, the electronic device (e.g., the electronic device 101 of FIG. 1, 2, or 3) may switch a screen displayed on a display (e.g., the display 310 of FIG. 3) to a preview screen 830 including preview images 501-4, 503-4, 505-4, and 507-4 having different compositions created from the image acquired through a second camera (e.g., the second camera 323 of FIG. 3), based on the user input for selecting the visual object 810. A user 1-3 may select the second image 507-4 having a composition desired by the user 1-3 from among the displayed preview images 501-4, 503-4, 505-4, and 507-4.

In an embodiment, the electronic device (e.g., the electronic device 101 of FIG. 1, 2, or 3) may detect a user input for selecting the second image 507-4. The electronic device (e.g., the electronic device 101 of FIG. 1, 2, or 3) may adjust an optical zoom magnification of the first camera (e.g., the first camera 321 of FIG. 1) so that an image captured by using the first camera (e.g., the first camera 321 of FIG. 1) has a composition corresponding to a composition of the second image 507-4, based on the user input for selecting the second image 507-4. The electronic device (e.g., the electronic device 101 of FIG. 1, 2, or 3) may be configured to display an image 807 acquired through the first camera (e.g., the first camera 321 of FIG. 1), based on the adjusted optical zoom magnification.

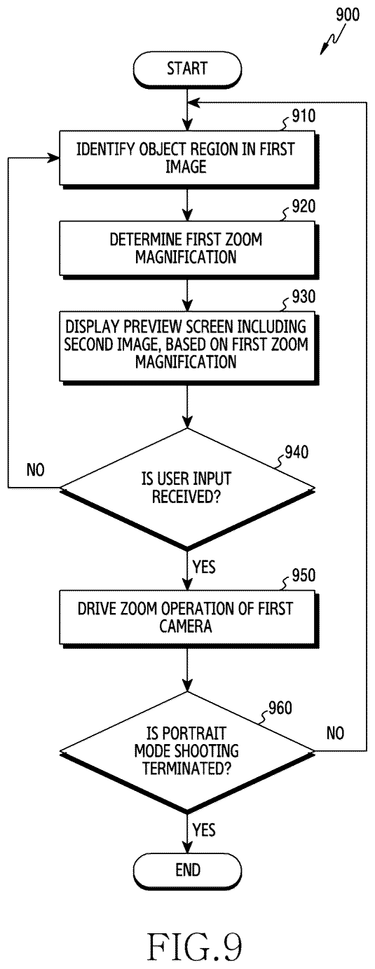

FIG. 9 is a flowchart 900 illustrating a process in which an electronic device (e.g., the electronic device 101 of FIG. 1, 2, or 3) drives a zoom operation of a first camera (e.g., the first camera 321 of FIG. 3) according to an embodiment. In the disclosure, it may be understood that the operation of the electronic device (e.g., the electronic device 101 of FIG. 1, 2, or 3) is performed by a processor (e.g., the processor 340 of FIG. 3) of the electronic device (e.g., the electronic device 101 of FIG. 1, 2, or 3) by executing instructions stored in a memory (e.g., the memory 330 of FIG. 3).

In operation 910, the electronic device (e.g., the electronic device 101 of FIG. 1, 2, or 3) may identify an object region in a first image acquired through a second camera (e.g., the second camera 323 of FIG. 3). For example, the electronic device (e.g., the electronic device 101 of FIG. 1, 2, or 3) may identify a region of pixels in which an object (e.g., a face, food, an animal) to be identified in the first image appears.

In operation 920, the electronic device (e.g., the electronic device 101 of FIG. 1, 2, or 3) according to an embodiment may determine a first zoom magnification, based on an area of the object region and a reference ratio. For example, the electronic device (e.g., the electronic device 101 of FIG. 1, 2, or 3) may determine the first zoom magnification such that a ratio of the object region occupied in the entire region corresponds to the reference ratio by enlarging or reducing the object region.

In operation 930, the electronic device (e.g., the electronic device 101 of FIG. 1, 2, or 3) according to an embodiment may display a preview screen including a second image, based on the determined first zoom magnification. In operation 930, the electronic device (e.g., the electronic device 101 of FIG. 1, 2, or 3) may display images having different compositions enlarged or reduced from the second image, together with the second image. In an embodiment, the electronic device (e.g., the electronic device 101 of FIG. 1, 2, or 3) may further display a preview image displayed based on the image acquired through the first camera (e.g., the first camera 321 of FIG. 3), together with the second image.

In operation 940, the electronic device (e.g., the electronic device 101 of FIG. 1, 2, or 3) according to an embodiment may determine whether a user input for the second image is received. When the user input is not received, the electronic device (e.g., the electronic device 101 of FIG. 1, 2, or 3) may repeatedly perform an operation of determining the first zoom magnification for the second image to maintain a composition of the second image. The operation of determining the optical zoom magnification of the first camera may be repeatedly performed to maintain a composition of a preview image provided based on the first camera (e.g., the first camera 321 of FIG. 3) in operation 930.

In operation 950, Upon receiving the user input for the second image, the electronic device (e.g., the electronic device 101 of FIG. 1, 2, or 3) may drive a zoom operation of the first camera (e.g., the first camera 321 of FIG. 3). In operation 950, the electronic device (e.g., the electronic device 101 of FIG. 1, 2, or 3) may determine a second zoom magnification such that an object ratio for an object identified in an image acquired through the first camera (e.g., the first camera 321 of FIG. 3) corresponds to an object ratio for an object identified in the selected second image. In operation 950, the electronic device (e.g., the electronic device 101 of FIG. 1, 2, or 3) may drive the zoom operation of the first camera (e.g., the first camera 321 of FIG. 3), based on the second zoom magnification.

In an embodiment, a process of the flowchart 900 may be performed while performing portrait mode shooting. In operation 960, the electronic device (e.g., the electronic device 101 of FIG. 1, 2, or 3) may repeatedly perform the operation 950 when the portrait mode shooting is not terminated. However, the portrait mode shooting is for explaining an embodiment, and the shooting mode is not limited to shooting a person. In addition, the operation 960 may be replaced with another operation for terminating a process other than the terminating of the shooting mode. For example, the operation 960 may be replaced with an operation of terminating a camera application other than the terminating of the portrait shooting mode.

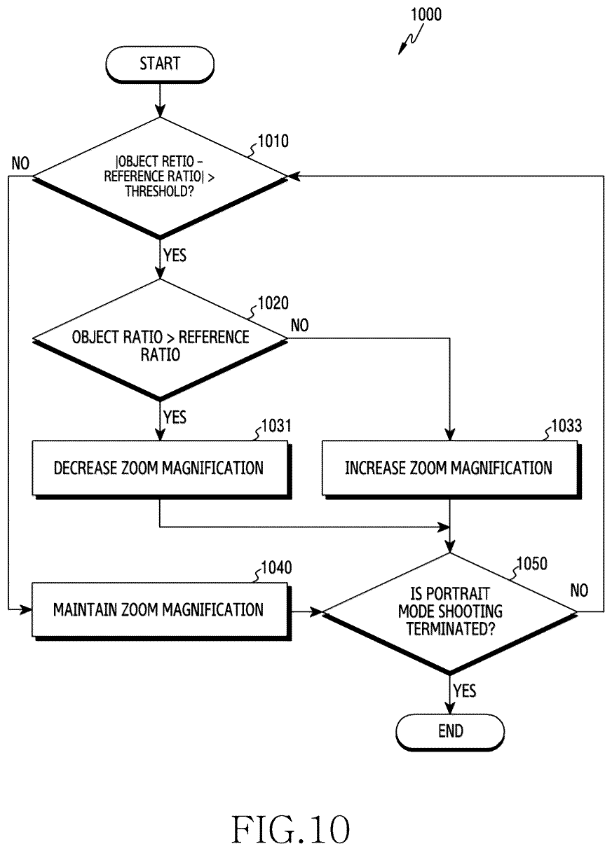

FIG. 10 is a flowchart 1000 illustrating a process in which an electronic device (e.g., the electronic device 101 of FIG. 1, 2, or 3) adjusts a zoom magnification according to an embodiment.

In an embodiment, when an object changes in a second image, the electronic device (e.g., the electronic device 101 of FIG. 1, 2, or 3) may adjust a first zoom magnification to maintain an object ratio in an image of a recommended composition provided through a display (e.g., the display 310 of FIG. 3). For example, when a subject is away from the electronic device (e.g., the electronic device 101 of FIG. 1, 2, or 3), since a size of an object in an image decreases, a magnification for acquiring the second image shall be increased.

In operation 1010, the electronic device (e.g., the electronic device 101 of FIG. 1, 2, or 3) may determine whether an absolute value for a difference between a reference ratio and an object ratio for an object identified in the second image is greater than a threshold. When the absolute value for the difference between the reference ratio and the object ratio is not greater than the threshold, since the object ratio is within a reference range from the reference ratio, in operation 1040, the electronic device (e.g., the electronic device 101 of FIG. 1, 2, or 3) may maintain the zoom magnification for the second image.

When the absolute value for the difference between the reference ratio and the object ratio is greater than the threshold, in operation 1020, the electronic device (e.g., the electronic device 101 of FIG. 1, 2, or 3) may determine whether the object ratio is greater than the reference ratio. When the object ratio is greater than the reference ratio, in operation 1031, the electronic device (e.g., the electronic device 101 of FIG. 1, 2, or 3) may decrease the zoom magnification such that an area in which the object is displayed in the second image is decreased. When the object ratio is less than the reference ratio, in operation 1033, the electronic device (e.g., the electronic device 101 of FIG. 1, 2, or 3) may increase the zoom magnification such that the area in which the object is displayed in the second image is increased.

The operations of the flowchart 1000 may be repeatedly performed while the electronic device (e.g., the electronic device 101 of FIG. 1, 2, or 3) executes a portrait shooting mode. However, the portrait mode shooting is for explaining an embodiment, and the shooting mode is not limited to shooting a person. In addition, the operation 1050 may be replaced with another operation for terminating a process other than the terminating of the shooting mode. For example, the operation 1050 may be replaced with an operation of terminating a camera application other than the terminating of the portrait shooting mode.

The flowchart 1000 of FIG. 10 may also be similarly applied as a process for adjusting an optical zoom magnification for maintaining a composition of an image provided through the first camera (e.g., the first camera 321 of FIG. 3). When the flowchart 1000 of FIG. 10 is applied to an operation of dynamically adjusting the optical zoom magnification of the first camera (e.g., the first camera 321 of FIG. 3), the reference ratio of the operations 1010 and 1020 may be a ratio corresponding to an object ratio of a recommended composition image (e.g., the second image 507-2 of FIG. 6) selected by a user.

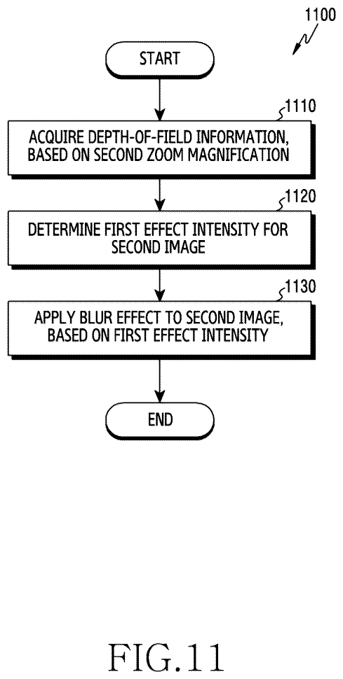

FIG. 11 is a flowchart 1100 illustrating a process in which an electronic device (e.g., the electronic device 101 of FIG. 1, 2, or 3) applies an image effect to a second image included in a preview screen according to an embodiment. The process of FIG. 11 may be performed, for example, in the operation 930 of displaying the preview screen of FIG. 9.

The electronic device (e.g., the electronic device 101 of FIG. 1, 2, or 3) according to an embodiment may acquire depth-of-field information, based on a first zoom magnification to be applied to a first camera (e.g., the first camera 321 of FIG. 3), optical information (e.g., a focal length corresponding to the first zoom magnification, an F-number, and a size of a sensor cell) of the first camera (e.g., the first camera 321 of FIG. 3), and information on a distance to a subject. The size of the sensor cell may be a fixed value. For example, when a user changes the zoom magnification by selecting a person composition, the focal length and the F-number change, which may result in a change in a depth of field. For example, even in a state where the zoom magnification is fixed, when a subject moves closer or farther away from the camera, there may be a change in the depth of field since a distance to the subject changes.

In operation 1110, upon selecting a corresponding second image for each of the second images (e.g., 501-2, 503-2, 505-2, and 507-2 of FIGS. 6, 501-4, 503-4, 505-4, and 507-4 of FIG. 6), the electronic device (e.g., the electronic device 101 of FIG. 1, 2, or 3) may acquire depth-of-field information, based on whether a specific second zoom magnification will be applied to the first camera (e.g., the first camera 321 of FIG. 3). The depth-of-field information may include, for example, front depth-of-field information DN and back depth-of-field information DF. The front depth-of-field information DN may refer to information corresponding to a distance to a lens from a point near the lens among regions to be focused. The back depth-of-field information DF may refer to information corresponding to a distance to the lens from a point far from the lens among the regions to be focused. For example, the front depth-of-field information DN and the back depth-of-field information DF may be determined based on Equation 1 below.

$${D}_{N} = \frac{{sf}^{2}}{{f}^{2} + Nc ( s - f )} , {D}_{F} = \frac{{sf}^{2}}{{f}^{2} - Nc ( s - f )} \qquad [ Equation 1 ]$$

In Equation 1, s may denote a distance from the lens to the focused subject, f may denote a focal length of the lens, N may denote an aperture value for the lens, and c may denote a circle of confusion. A full Depth of Field (DOF) may be a difference between front depth-of-field information and back depth-of-field information. For example, the full DOF may be determined based on Equation 2 below.

$$DOF = {D}_{F} - {D}_{N} = \frac{2 {Ncf}^{2} s ( s - f )}{{f}^{4} - {N}^{2} {{c}^{2} ( s - f )}^{2}} \qquad [ Equation 2 ]$$

In operation 1110, the electronic device (e.g., the electronic device 101 of FIG. 1, 2, or 3) may predict depth-of-field information for a subject captured when a second zoom magnification is applied to the first camera (e.g., the first camera 321 of FIG. 1). In operation 1110, when a second image includes a plurality of images corresponding to different compositions, the electronic device (e.g., the electronic device 101 of FIG. 1, 2, or 3) may further acquire different depth-of-field information, based on a zoom magnification corresponding to each of the images.

In operation 1120, the electronic device (e.g., the electronic device 101 of FIG. 1, 2, or 3) may determine first effect intensity for a second image (any one of second images, when the second image is a plurality of images having different compositions), based on depth-of-field information. For example, the electronic device (e.g., the electronic device 101 of FIG. 1, 2, or 3) may determine the first effect intensity corresponding to a bokeh effect appearing in a third image acquired through the first camera (e.g., the first camera 321 of FIG. 3), based on a second zoom magnification. When different depth-of-field information corresponding to an image having a composition different from that of the image is further acquired from the second image, the electronic device (e.g., the electronic device 101 of FIG. 1, 2, or 3) may further determine second effect intensity corresponding to the different depth-of-field information.

In operation 1130, the electronic device (e.g., the electronic device 101 of FIG. 1, 2, or 3) may apply a blur effect to the second image, based on the determined first effect intensity. The electronic device (e.g., the electronic device 101 of FIG. 1, 2, or 3) may differently apply the blur effect to subjects each of which being captured with a different distance in the second image, by matching 3-dimensional depth information with the front depth-of-field information and the back depth-of-field information. For example, when an image is acquired through the first camera (e.g., the first camera 321 of FIG. 3), based on the second zoom magnification, the blur effect is not applied or is applied with low intensity to a region in which a subject to be focused in the image to be acquired through the first camera (e.g., the first camera 321 of FIG. 3) is captured in the second image, and the blur effect may be applied with high intensity to a region in which the subject not to be focused is captured in the second image. The blur effect may be applied with different intensity to an image having a different composition, based on different effect intensity.

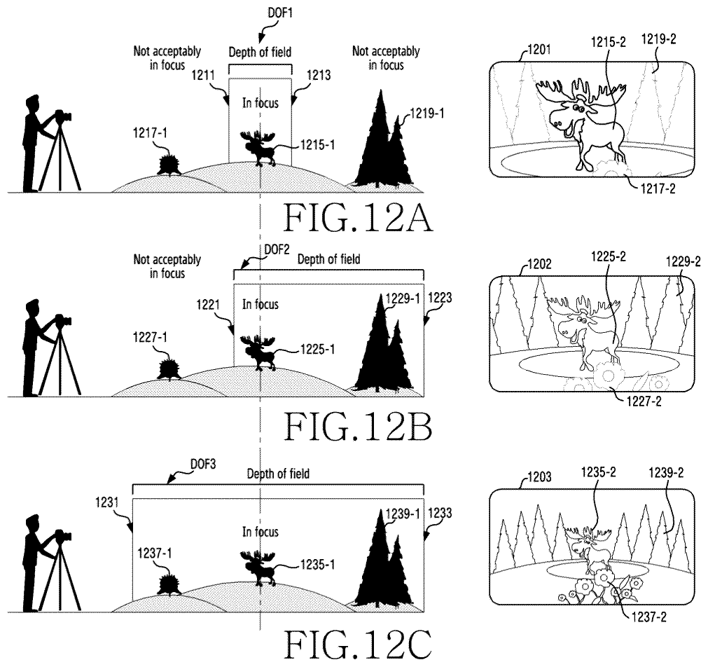

FIGS. 12A, 12B, and 12C are drawings for explaining depth-of-field information for applying an image effect to a second image by an electronic device (e.g., the electronic device 101 of FIG. 1, 2, or 3) according to an embodiment.

The electronic device (e.g., the electronic device 101 of FIG. 1, 2, or 3) according to an embodiment may correct an image captured by using a second camera (e.g., a telescopic camera) such that a bokeh effect is exhibited similarly to an image to be captured by using a first camera (e.g., a continuous optical zoom camera), based on depth-of-field information. A subject may be presented clearly or blurred in a captured image according to a distance from a camera to the subject and a depth of field corresponding to a zoom magnification applied to a continuous optical zoom camera.

As shown in FIG. 12A, for example, when the continuous optical zoom camera captures an image 1201, based on a shallow depth of field DOF1 (when capturing the image 1201, based on a high zoom magnification), a region 1215-2 in which a subject 1215-1 focused by a lens is captured may appear clearly. However, regions 1217-2 and 1219-2 in which a subject 1217-1 positioned closer than a front depth of field 1211 and a subject 1219-1 positioned farther than a back depth of field 1213 are captured, may appear blurry.

As shown in FIG. 12B, for example, when the continuous optical zoom camera captures an image 1202, based on an intermediary depth of field DOF2 (when capturing the image 1202, based on an intermediary zoom magnification), a region 1225-2 in which a subject 1225-1 focused by a lens is captured may appear clearly. In addition, since a back depth of field 1223 is deeper than the shallow depth of field DOF1, a region 1229-2 in which a subject 1229-1 positioned farther than the focused subject 1225-1 is captured may also appear clearly. However, a region 1227-2 in which a subject 1227-1 positioned closer than a front depth of field 1221 is captured may appear blurry.

As shown in FIG. 12 C, for example, when the continuous optical zoom camera captures an image 1203, based on a deep depth of field DOF3 (when capturing the image 1203, based on a low zoom magnification), regions 1235-2, 1237-2, and 1239-2 in which subjects 1237-1 and 1239-1 positioned between a front depth of field 1231 and a back depth of field 1233 are captured, including a subject 1235-1 focused by a lens, may appear clearly.

The electronic device (e.g., the electronic device 101 of FIG. 1, 2, or 3) according to an embodiment may determine effect intensity indicating a degree to which each region is blurred in an image captured by using the second camera, in accordance with a depth of field depending on a zoom magnification of the first camera, based on a distance to a subject in the image captured based on the second camera having a deep depth of field. The electronic device (e.g., the electronic device 101 of FIG. 1, 2, or 3) may apply a bokeh effect to the image, based on the effect intensity.

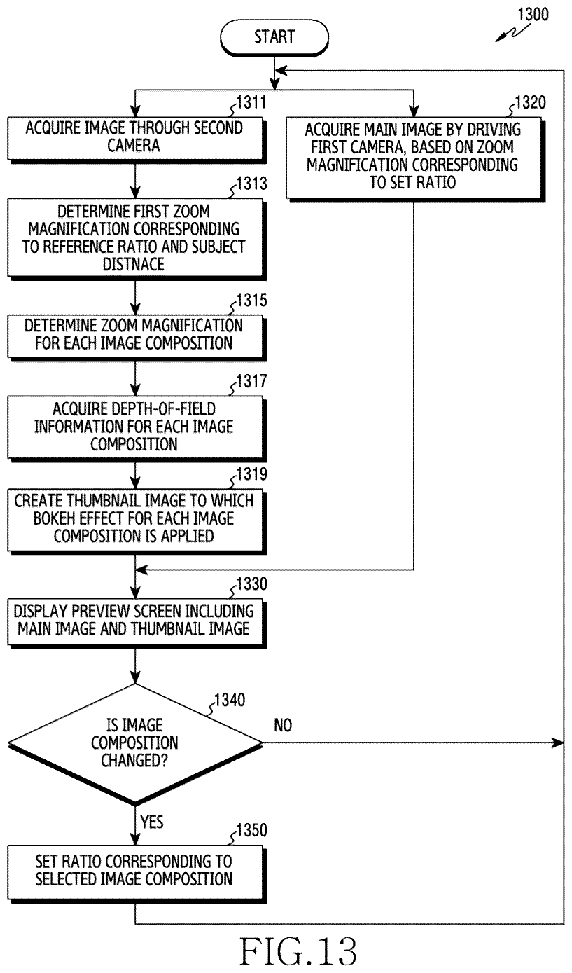

FIG. 13 is a flowchart 1300 illustrating a process in which an electronic device (e.g., the electronic device 101 of FIG. 1, 2, or 3) acquires an image by using a first camera (e.g., the first camera 321 of FIG. 3) and a second camera (e.g., the second camera 323 of FIG. 3) according to an embodiment.

In operation 1311, the electronic device (e.g., the electronic device 101 of FIG. 1, 2, or 3) according to an embodiment may acquire a first image through the second camera (e.g., the second camera 323 of FIG. 3). In operation 1313, the electronic device (e.g., the electronic device 101 of FIG. 1, 2, or 3) according to an embodiment may determine a first zoom magnification corresponding to a reference ratio and a distance to a subject captured in the first image. In operation 1315, the electronic device (e.g., the electronic device 101 of FIG. 1, 2, or 3) may determine a zoom magnification for each of a plurality of image compositions, based on the first zoom magnification. The zoom magnification for each of the plurality of image compositions may be a magnification obtained by multiplying the first zoom magnification by a pare-set ratio.

In operation 1317, the electronic device (e.g., the electronic device 101 of FIG. 1, 2, or 3) may acquire depth-of-field information for each image composition to apply a bokeh effect to a thumbnail image. The depth-of-field information for each image composition may refer to depth-of-field information for a case where an image is captured by applying an optical zoom magnification for a corresponding image composition to the first camera (e.g., the first camera 321 of FIG. 3). In an embodiment, the electronic device (e.g., the electronic device 101 of FIG. 1, 2, or 3) may determine the depth-of-field information by using at least one of optical information which changes depending on a zoom magnification in the first camera (e.g., the first camera 321 of FIG. 3) and information on a distance to a subject. In operation 1319, the electronic device (e.g., the electronic device 101 of FIG. 1, 2, or 3) may create a plurality of thumbnail images to which a bokeh effect for each image composition is applied.

In operation 1320, the electronic device (e.g., the electronic device 101 of FIG. 1, 2, or 3) may drive an optical zoom function of the first camera (e.g., the first camera 321 of FIG. 3), based on a zoom magnification corresponding to a set ratio. The electronic device (e.g., the electronic device 101 of FIG. 1, 2, or 3) may acquire a main image through the driven first camera (e.g., the first camera 321 of FIG. 3). The set ratio may refer to a ratio of an area occupied by a to-be-identified object to an entire image in the thumbnail image selected by a user from among the plurality of thumbnail images. When the user does not select the thumbnail image, the set ratio may be a ratio set by default. A zoom magnification corresponding to the set ratio may refer to a magnification of an optical zoom function which allows a ratio of an area occupied by an object identified in an image acquired through the first camera (e.g., the first camera 321 of FIG. 3) to correspond to the set ratio.

In operation 1330, the electronic device (e.g., the electronic device 101 of FIG. 1, 2, or 3) may display a preview screen including the main image and the thumbnail image through a display (e.g., the display 310 of FIG. 3). In operation 1340, the electronic device (e.g., the electronic device 101 of FIG. 1, 2, or 3) may determine whether to change an image composition, based on whether a user input for the thumbnail image is detected. When the image composition changes, in operation 1350, the electronic device (e.g., the electronic device 101 of FIG. 1, 2, or 3) may set a ratio corresponding to a selected image composition. The electronic device (e.g., the electronic device 101 of FIG. 1, 2, or 3) may perform the operation 1320, based on the set ratio.

It may be required to adjust a zoom magnification to take a picture with a desired composition when capturing an image. For example, it is necessary to provide an image, based on an increased zoom magnification when an area occupied by a region of a main subject being captured in the image is excessively small. It may be inconvenient to directly set the zoom magnification corresponding to a composition desired by a user. There is a need to provide the user with preview images of various recommended compositions so that the user selects a desired image from among the preview images to easily acquire an image of an appropriate composition.

When an image is provided by using a camera which provides a continuous optical zoom function, an image corresponding to various zoom magnifications may be acquired without deterioration in image quality. However, since the image is acquired based on a currently set zoom magnification, the camera has a limitation in providing a preview image. For example, it is difficult to create a preview image for a composition to be captured based on a wider field of view, compared to the currently set zoom magnification.

On the contrary, in a case where the image is provided based on digital zoom, deterioration in image quality may occur when the acquired image is enlarged or reduced through image processing.

Accordingly, there is a need for a method and apparatus capable of easily acquiring an image of a desired composition without deterioration in image quality.

Advantages acquired in the disclosure are not limited to the aforementioned advantages, and other advantages not mentioned herein may be clearly understood by those skilled in the art to which the disclosure pertains from the following descriptions.

An electronic device according to an embodiment may include a display, a first camera having an optical system configured movably to adjust a magnification of an image to be captured and supporting a first field of view which changes within a specific range by the movement of the optical system, a second camera supporting a wider field of view than the first field of view, and at least one processor. The at least one processor may be configured to identify an object region in a first image captured by using the second camera. The at least one processor may be configured to determine a first zoom magnification, based on an area of the object region and a pre-set reference ratio. The at least one processor may be configured to display, through the display, a preview screen including a second image enlarged or reduced from at least part of the first image, based on the first zoom magnification. The at least one processor may be configured to receive a user input for the second image. The at least one processor may be configured to drive a zoom operation of the first camera such that a zoom magnification of the first camera is adjusted based on a second zoom magnification determined based on the user input.

According to an embodiment, the at least one processor may be configured to determine an object ratio of an area occupied by the object region in the second image, and adjust the at least one first zoom magnification, based on whether the at least one object ratio corresponds to the at least one reference ratio.

According to an embodiment, the at least one processor may be configured to acquire a third image captured by using the first camera, and determine the second zoom magnification such that a ratio of a region, in which a subject corresponding to the object region is captured, occupied in the third image corresponds to the reference ratio.

According to an embodiment, the at least one processor may be configured to display a preview image further including the third image through the display.

According to an embodiment, the first zoom magnification may be a magnification for digital zoom which enlarges or reduces an image through image processing for image data acquired through the second camera. The second zoom magnification may be a magnification for optical zoom which adjusts a magnification of an image acquired through the first camera by controlling the optical system of the first camera.

According to an embodiment, the at least one processor may be configured to acquire depth-of-field information for a subject included in the first image, determine first effect intensify for the second image, based on the depth-of-field information, and blur at least a part of the second image, based on the first effect intensify.

According to an embodiment, the at least one processor may be configured to display the preview screen further including a fourth image through the display. The fourth image may include an image enlarged or reduced from the first image, based on a third magnification obtained by multiplying the first zoom magnification by a pre-set ratio.

According to an embodiment, the at least one processor may be configured to determine second effect intensity different from the first effect intensity, based on the third magnification, and blur at least a part of the fourth image, based on the second effect intensity.

According to an embodiment, the at least one processor may be configured to adjust the first effect intensity, based on a change in the first zoom magnification.

According to an embodiment, the at least one processor may be configured to identify a face in the first image, and determine a region corresponding to the identified face as the object region.

According to an embodiment, a method of operating an electronic device including a first camera having an optical system configured movably to adjust a magnification of an image to be captured and supporting a first field of view which changes within a specific range by the movement of the optical system and a second camera supporting a wider field of view than the first field of view may include identifying an object region in a first image captured by using the second camera. The method may include determining a first zoom magnification, based on an area of the object region and a pre-set reference ratio. The method may include displaying a preview screen including a second image enlarged or reduced from at least part of the first image, based on the first zoom magnification. The method may include receiving a user input for the second image. The method may include driving a zoom operation of the first camera such that a zoom magnification of the first camera is adjusted based on a second zoom magnification determined based on the user input.

The method of operating the electronic device according to an embodiment may include determining an object ratio of an area occupied by the object region in the second image, and adjusting the at least one first zoom magnification, based on whether the at least one object ratio corresponds to the at least one reference ratio.

The method of operating the electronic device according to an embodiment may include acquiring a third image captured by using the first camera, and determining the second zoom magnification such that a ratio of a region, in which a subject corresponding to the object region is captured, occupied in the third image corresponds to the reference ratio.

According to an embodiment, the displaying of the preview screen may include displaying a preview image further including the second image and the third image.

According to an embodiment, the first zoom magnification may be a magnification for digital zoom which enlarges or reduces an image through image processing for image data acquired through the second camera. The second zoom magnification may be a magnification for optical zoom which adjusts a magnification of an image acquired through the first camera by controlling the optical system of the first camera.

The method of operating the electronic device according to an embodiment may include acquiring depth-of-field information for a subject included in the first image, based on the second zoom magnification corresponding to the first image, determining first effect intensify for the second image, based on the depth-of-field information, and blurring at least a part of the second image, based on the first effect intensify.

According to an embodiment, the displaying of the preview screen may include displaying a preview screen including the second image and the fourth image. The fourth image may include an image enlarged or reduced from the first image, based on a third magnification obtained by multiplying the first zoom magnification by a pre-set ratio.

The method of operating the electronic device according to an embodiment may include determining second effect intensity different from the first effect intensity, based on the third magnification, and blurring at least a part of the fourth image, based on the second effect intensity.

According to an embodiment, the method may further include adjusting the first effect intensity, based on a change in the first zoom magnification.

According to an embodiment, the identifying of the object region may include identifying a face in the first image. According to various embodiments, an electronic device in which a user is able to easily identify and select a recommended image composition, and a method of operating the electronic device may be provided.

According to various embodiments, an electronic device capable of maintaining a composition for capturing an image even if a distance between the electronic device and a subject changes, and an operating method thereof may be provided.

According to various embodiments, an electronic device capable of providing a preview image similarly to an image acquired through a continuous optical zoom operation by predicting an effect applied to the image, when a zoom magnification changes through the continuous optical zoom operation, and an operating method thereof may be provided.

According to various embodiments, an electronic device which allows a user to acquire an image without deterioration in image quality while easily selecting a composition, and an operating method thereof may be provided.

Advantages acquired in the disclosure are not limited to the aforementioned advantages, and other advantages not mentioned herein may be clearly understood by those skilled in the art to which the disclosure pertains from the following descriptions.

Methods based on the embodiments disclosed in the claims and/or specification of the disclosure may be implemented in hardware, software, or a combination of both.

When implemented in software, a computer readable recording medium for storing one or more programs (i.e., software modules) may be provided. The one or more programs stored in the computer readable recording medium are configured for execution performed by one or more processors in the electronic device. The one or more programs include instructions for allowing the electronic device to execute the methods based on the embodiments disclosed in the claims and/or specification of the disclosure.

The program (i.e., the software module or software) may be stored in a random access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs) or other forms of optical storage devices, and a magnetic cassette. Alternatively, the program may be stored in a memory configured in combination of all or some of these storage media. In addition, the configured memory may be plural in number.

Further, the program may be stored in an attachable storage device capable of accessing the electronic device through a communication network such as the Internet, an Intranet, a Local Area Network (LAN), a Wide LAN (WLAN), or a Storage Area Network (SAN) or a communication network configured by combining the networks. The storage device may have access to a device for performing an embodiment of the disclosure via an external port. In addition, an additional storage device on a communication network may have access to the device for performing the embodiment of the disclosure.

In the aforementioned specific embodiments of the disclosure, a component included in the disclosure is expressed in a singular or plural form according to the specific embodiment proposed herein. However, the singular or plural expression is selected properly for a situation proposed for the convenience of explanation, and thus the various embodiments of the disclosure are not limited to a single or a plurality of components. Therefore, a component expressed in a plural form may also be expressed in a singular form, or vice versa.

In addition, in the disclosure, the term “unit”, “module”, or the like may be a hardware component such as a processor or a circuit, and/or a software component executed by the hardware component such as the processor.

The “unit” and the “module” may be implemented by a program stored in an addressable storage medium and executable by the processor. For example, the “unit” and “module” may be implemented by software components, object-oriented software components, class components, and task components, processes, functions, attributes, procedures, subroutines, segments of program code, drivers, firmware, microcode, circuitry, data, databases, data structures, tables, arrays, and variables.

Specific implementations described in the disclosure are only one embodiment, and do not limit the scope of the disclosure in any way. For brevity of the specification, descriptions on the conventional electronic components, control systems, software, and other functional aspects of the systems may be omitted.

In addition, in the disclosure, “including at least one of a, b, or c” may mean “including only a”, “including only b”, “including only c”, “including a and b”, “including b and c”, “including a and c”, or “including a, b, and c”.

While the disclosure has been shown and described with reference to certain preferred embodiments thereof, it will be understood by those skilled in the art that various changes in form and details may be made therein without departing from the spirit and scope of the disclosure as defined by the appended claims. Therefore, the scope of the disclosure is defined not by the detailed description thereof but by the appended claims, and all differences within equivalents of the scope will be construed as being included in the disclosure.

1. An electronic device comprising:
a display;
a first camera having an optical system configured movably to adjust a magnification of an image to be captured and having a first field of view which changes within a specific range by the movement of the optical system;
a second camera having a wider field of view than the first field of view;
at least one processor; and
memory storing computer-executable instructions,
wherein the instructions, when being executed by the at least one processor individually or collectively, causes the electronic device to:
identify an object region in a first image captured by the second camera;
determine a first zoom magnification based on an area of the object region and at least one pre-set reference ratio;
display, through the display, a preview screen comprising a second image scaled from at least part of the first image, based on the first zoom magnification;
receive a user input for the second image; and
drive a zoom operation of the first camera such that a zoom magnification of the first camera is adjusted based on a second zoom magnification determined based on the user input.

2. The electronic device of claim 1, wherein the instructions, when being executed by the at least one processor individually or collectively, further causes the electronic device to:
determine at least one object ratio of an area occupied by the object region in the second image; and
adjust the at least one first zoom magnification based on whether the at least one object ratio corresponds to the at least one pre-set reference ratio.

3. The electronic device of claim 1, wherein the instructions, when being executed by the at least one processor individually or collectively, further causes the electronic device to:
acquire a third image captured by the first camera; and
determine the second zoom magnification such that a ratio of a region occupied in the third image corresponds to the reference ratio, wherein the region is a region in which a subject corresponding to the object region is captured.

4. The electronic device of claim 3, wherein the instructions, when being executed by the at least one processor individually or collectively, further causes the electronic device to display, through the display, a preview image comprising the third image.

5. The electronic device of claim 1,
wherein the first zoom magnification is a magnification for digital zoom which enlarges or reduces an image through image processing for image data acquired through the second camera, and
wherein the second zoom magnification is a magnification for optical zoom which adjusts a magnification of an image acquired through the first camera by controlling the optical system of the first camera.

6. The electronic device of claim 1, wherein the instructions, when being executed by the at least one processor individually or collectively, further causes the electronic device to:
acquire depth-of-field information for a subject included in the first image;
determine a first effect intensify for the second image based on the depth-of-field information; and
blur at least a part of the second image based on the first effect intensify.

7. The electronic device of claim 6, wherein the instructions, when being executed by the at least one processor individually or collectively, further causes the electronic device to display, through the display, the preview screen further including a fourth image, and
wherein the fourth image includes an image scaled from the first image based on a third magnification obtained by multiplying the first zoom magnification by a pre-set ratio.

8. The electronic device of claim 7, wherein the instructions, when being executed by the at least one processor individually or collectively, further causes the electronic device to:
determine a second effect intensity different from the first effect intensity based on the third magnification; and
blur at least a part of the fourth image based on the second effect intensity.

9. The electronic device of claim 6, wherein the instructions, when being executed by the at least one processor individually or collectively, further causes the electronic device to adjust the first effect intensity based on a change in the first zoom magnification.

10. The electronic device of claim 1, wherein the instructions, when being executed by the at least one processor individually or collectively, further causes the electronic device to:
identify a face in the first image; and
determine a region corresponding to the identified face as the object region.

11. A method of operating an electronic device including a first camera having an optical system configured movably to adjust a magnification of an image to be captured and having a first field of view which changes within a specific range by the movement of the optical system and a second camera having a wider field of view than the first field of view, the method comprising:
identifying an object region in a first image captured by the second camera;
determining a first zoom magnification based on an area of the object region and at least one pre-set reference ratio;
displaying a preview screen comprising a second image scaled from at least part of the first image, based on the first zoom magnification;
receiving a user input for the second image; and
driving a zoom operation of the first camera such that a zoom magnification of the first camera is adjusted based on a second zoom magnification determined based on the user input.

12. The method of claim 11, further comprising:
determining at least one object ratio of an area occupied by the object region in the second image; and
adjusting the at least one first zoom magnification based on whether the at least one object ratio corresponds to the at least one pre-set reference ratio.

13. The method of claim 11, further comprising:
acquiring a third image captured by the first camera; and
determining the second zoom magnification such that a ratio of a region occupied in the third image corresponds to the at least one pre-set reference ratio, the region being a region in which a subject corresponding to the object region is captured.

14. The method of claim 13, wherein the displaying of the preview screen comprises displaying a preview image comprising the third image.

15. The method of claim 11,
wherein the first zoom magnification is a magnification for digital zoom which enlarges or reduces an image through image processing for image data acquired through the second camera, and
wherein the second zoom magnification is a magnification for optical zoom which adjusts a magnification of an image acquired through the first camera by controlling the optical system of the first camera.

16. The method of claim 11, further comprising:
acquiring depth-of-field information for a subject included in the first image;
determining a first effect intensify for the second image based on the depth-of-field information; and
blurring at least a part of the second image based on the first effect intensify

17. The method of claim 16, wherein the displaying the preview screen comprises displaying a preview screen comprising the second image and a fourth image, and
wherein the fourth image includes an image scaled from the first image based on a third magnification obtained by multiplying the first zoom magnification by a pre-set ratio.

18. The method of claim 17, further comprising:
determining a second effect intensity different from the first effect intensity based on the third magnification; and
blurring at least a part of the fourth image based on the second effect intensity.

19. The method of claim 16, further comprising, adjusting the first effect intensity based on a change in the first zoom magnification.

20. The method of claim 11, wherein the identifying the object region comprises identifying a face in the first image.
